(19) United States
(12) Patent Application Publication
(10) Pub. No.: US 2025/0313099 A1
(43) Pub. Date: Oct. 9, 2025

(54) LOAD-BEARING STRUCTURAL PANEL ASSEMBLIES WITH TAB MATRIX INTERLOCKS AND METHODS FOR MAKING THE SAME

(71) Applicant: GM GLOBAL TECHNOLOGY OPERATIONS LLC, Detroit, MI (US)

(72) Inventors: Kevin K. Parkila, Royal Oak, MI (US); Joel S. Hooton, Chesterfield, MI (US)

(73) Assignee: GM GLOBAL TECHNOLOGY OPERATIONS LLC, Detroit, MI (US)

(21) Appl. No.: 18/630,443

(22) Filed: Apr. 9, 2024

(51) Int. Cl. B60L 50/60; B32B 3/06; B32B 3/30; B32B 15/01; B32B 37/18; B32B 38/00; B60K 1/04; B62D 25/20

(52) U.S. Cl. CPC B60L 50/66; B32B 3/06; B32B 3/30; B32B 15/01; B32B 37/18; B32B 38/0012; B60K 1/04; B62D 25/2072; B32B 2605/08; B60K 2001/0438

(57) ABSTRACT

Presented are multilayer structural panel assemblies with tab matrix interlocks, methods for making/using such panel assemblies, and vehicles equipped with such panel assemblies. A structural panel assembly includes or, for some applications, consists essentially of two interconnected panels: a first (base) panel that is formed, in whole or in part, from a first metallic material, and a second (cover) panel that is formed, in whole or in part, from a second metallic material, which may be the same as or distinct from the first metallic material. An inward-facing (inboard) face of the first panel faces an inboard face of the second panel. The second panel is fabricating to include interlock tabs that are arranged in a predefined matrix pattern. The interlock tabs project at an oblique angle from the second panel's inboard face and rigidly mount to the first panel's inboard face to thereby join the two panels.

### INTRODUCTION

The present disclosure relates generally to multilayer structural panel assemblies. More specifically, aspects of this disclosure relate to load-bearing and load-transferring structural panel assemblies for motor vehicles.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, corner modules, road wheels, etc.). Automobiles have historically been powered by a reciprocating-piston type internal combustion engine (ICE) assembly due to its ready availability and relatively high energy density, light weight, and overall efficiency. Such engines include compression-ignited (CI) diesel engines, spark-ignited (SI) gasoline engines, two, four, and six-stroke architectures, and rotary engines, as some non-limiting examples. Hybrid-electric and full-electric vehicles (collectively “electric-drive vehicles”), on the other hand, utilize alternative power sources to propel the vehicle and, thus, minimize or eliminate reliance on a fossil-fuel based engine for tractive power.

Load-bearing “skeletal” chassis frames are designed to support a vehicle's powertrain, steering and braking systems, passengers, etc., during static loading and to contribute toward vehicle stiffness and force attenuation during dynamic loading. Some chassis frames have either a ladder-like or a unibody construction with opposing rocker side rails that are connected by a series of transversely oriented cross members. Projecting from front and rear ends of the rocker side rails are respective pairs of cradle and subframe rails that are connected via cross members to define a front cradle and a rear subframe. For some HEV architectures, the engine, transmission, and front suspension is generally supported by the front cradle, whereas the electric motor, fuel tank, and rear suspension are generally supported by the rear subframe. Electric-drive vehicles generally support the weight of a traction battery pack on a subjacent support panel, which is anchored to the chassis frame and packaged within a rear trunk compartment or underneath a passenger cabin floorboard.

### SUMMARY

Presented below are multilayer structural panel assemblies with tab matrix interlocks, methods for making and methods for using such panel assemblies, and motor vehicles equipped with such panel assemblies. By way of illustration, a lightweight and high-strength structural panel assembly may be fabricated as a bipartite construction that consists essentially of two sheet-metal panels that are joined by a matrix of tabs projecting from one panel and secured to the other. Some designs laser cut or press punch a predefined pattern of tabs from a top panel, bend the tabs downwards to a desired angle, and then weld or fasten the tabs to a bottom panel. In plan view, the tabs may be arranged in rectangular, radial, square, or random flat-matrix patterns. Interposed body portions of the tabs may project at an oblique angle from the originating plate and secure to the mating plate. Each tab may take on a regular geometric form, such as a rectangular, hexagonal, or elliptical-shaped tab, or an irregular geometric form, such as a lightbulb-shaped tab that is typified by a rectangular body section adjoining an oval head section. This simplified panel assembly design enables high-speed production through versatile manufacturing processes, such as progressive or transfer die stamping, or more flexible options, such as laser or waterjet cutting. Joining of the panels may be achieved using spot welding or laser welding or, alternatively, using grommets, rivets or other mechanical fasteners.

It is envisioned that the panel tabs and their arrangement may be customized to accommodate different loading conditions and varying material responses. Additionally, the open matrix design of the load-bearing and load-transferring structural panel assembly may enable the use of inter-panel void space for various purposes, such as transverse reinforcement retention bars, fluid ducting, electrical routing, and structural foam. The open matrix design may also be employed to provide efficient fluid drainage and convective thermal cooling, which may otherwise be precluded by closed “sandwich-style” panel structures. In addition to being implemented as load-bearing and load-transferring shear panels for supporting and protecting electric vehicle batteries, disclosed panel assembly designs may be adapted for use in other structural panel applications and, for that matter, may be used in both automotive and non-automotive applications alike. For instance, the tab array panel may enable an open “MOLLE” style retention system, which may be implemented for customer-facing storage applications in a van or for attaching secondary components during vehicle processing. Disclosed panel assemblies may be used for various other purposes: vehicle body structures (e.g., floors, sidewalls, front of dashboard), vehicle battery trays (upper and lower panels), truck or trailer beds, loading platforms for wheelchair lifts, as well as architectural or building applications.

Attendant benefits for at least some of the disclosed concepts include a high-specific-stiffness structural panel assembly with minimal parts and reduced manufacturing steps. Some designs, for example, may consist essentially of two sheet-metal panels that are joined by punching tabs from one panel and welding those tabs to the other panel. Doing so eliminates superfluous parts, such as foam cores, polymeric fascias, central mounting structures, mounting brackets, fasteners, etc., with a concomitant reduction in total weight, part count, assembly time, and related expenses. Other attendant benefits may include a commodity style panel that may be mass produced through adapted continuous manufacturing processes and may be readily scaled and customized for innumerable applications. Overall, disclosed multilayer structural panel assemblies may offer a lightweight, versatile, and efficient solution for structural vehicle panels. These panel assemblies may also offer flexibility in material selection, as they may be used with various materials that may be cut, bent, and welded, and may enable a variety of different continuous manufacturing processes, which improves efficiency and productivity.

Aspects of this disclosure are directed to multilayer structural panel assemblies with tab matrix interlocks. In an example, a structural panel assembly includes or, for some applications, consists essentially of two interconnected panels: a first (base) panel that is formed, in whole or in part, from a first (base panel) metallic material, and a second (cover) panel that is formed, in whole or in part, from a second (cover panel) metallic material, which may be the same as or distinct from the first panel's metallic material. An inward-facing (first inboard) face of the first panel faces an inward-facing (second inboard) face of the second panel. The second panel is punched, cut, stamped, die cast, etc. (collectively “machined”) to include multiple interlock tabs that are arranged in a predefined matrix pattern. These interlock tabs project at an oblique angle (e.g., about 30 to 60 degrees)) (° from the second panel's inboard face and rigidly mount (e.g., via welds or fasteners) to the first panel's inboard face to thereby join the two panels.

Additional aspects of this disclosure are directed to vehicles equipped with load-bearing and load-transferring shear panel assemblies for supporting and protecting in-vehicle batteries, fuel cells, fuel tanks, etc. As used herein, the terms “vehicle” and “motor vehicle” may be used interchangeably and synonymously to include any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles (ATV), motorcycles, farm equipment, aircraft, watercraft, spacecraft, etc. In an example, a motor vehicle includes a vehicle body with an internal chassis frame, a passenger compartment, multiple road wheels mounted to the vehicle body (e.g., via corner modules coupled to the unibody or body-on-frame chassis), and other standard original equipment. For electric-drive vehicle applications, one or more electric traction motors operate alone (e.g., for FEV powertrains) or in conjunction with an internal combustion engine assembly (e.g., for HEV powertrains) to selectively drive one or more of the road wheels to propel the vehicle. A rechargeable energy storage system (RESS) with one or more traction battery packs is attached to the vehicle body and is operable to power the traction motor(s), in-vehicle accessories, heating, ventilation, and air conditioning (HVAC) system, etc.

Continuing with the discussion of the foregoing example, the motor vehicle is also equipped with a structural shear panel assembly, which is rigidly mounted to the vehicle chassis frame and securely supports the traction battery pack(s). The shear panel assembly may include or, optionally, may consist essentially of two interlocked panels, each of which is integrally formed from a metallic material as a single-piece, unitary panel structure that has opposing inboard and outboard faces. The two panels are stacked in spaced face-to-face relation such that their inboard faces face each other. One of the panels is fabricated with multiple interlock tabs that are arranged in a predefined matrix pattern. These interlock tabs project at an oblique angle from the inboard face of one panel and are rigidly mounted via weld joints to the inboard face of the other panel to thereby join together the panels. For tripartite and quadripartite constructions, the shear panel assembly may incorporate a skid plate, a battery pack tray, a noise-attenuating polymer core, a structural foam core, surface coatings, etc.

Further aspects of this disclosure are directed to manufacturing systems, workflow processes, and control logic for making or for using any of the herein described structural panel assemblies, battery mounting systems, and motor vehicles. In an example, a method is presented for manufacturing a structural panel assembly. This representative method includes, in any order and in any combination with any of the above and below disclosed options and features: receiving a first panel formed with a first metallic material and having a first inboard face opposite a first outboard face; receiving a second panel formed with a second metallic material and having a second inboard face opposite a second outboard face; aligning the first and second panels such that the second inboard face faces the first inboard face; machining the second panel to include a plurality of interlock tabs arranged in a predefined matrix pattern; bending the interlock tabs to project at an oblique angle from the second inboard face; and mounting the interlock tabs to the first inboard face to thereby join the first and second panels.

For any of the disclosed panel assemblies, vehicles, and methods, the tab-originating (second) panel, including the matrix of interlock tabs, may be integrally formed as a single-piece structure from a metallic material. In the same vein, the tab-receiving (first) panel may be integrally formed as a single-piece structure from a metallic material, which may be similar to or distinct from the metallic material of its mating panel. As another option, each interlock tab may have an elongated and contoured shape with a tab head integral with a tab body. In this instance, the tab body is adjoined at one end thereof to the tab head and at an opposite end thereof to the second panel. The body segment of each tab projects at the oblique angle from the second panel's inboard face, whereas the head segment of each tab rigidly mounts to the first panel's inboard face. It may be desirable that the tab body be substantially flat and rectangular, the tab head be substantially flat and oval, and the tab head projects at an oblique angle (e.g., about 120° to about) 150° from the tab body.

For any of the disclosed panel assemblies, vehicles, and methods, the tab-originating (second) panel may be manufactured with multiple tab slots that are aligned with and, thus, arranged in the same predefined matrix pattern as the interlock tabs. In this instance, each of the interlock tabs may project from an inner edge of a respective one of the tab slots. As another option, each tab slot may have an elongated shape with a tab slot head that adjoins a respective end of a tab slot body. To accommodate a weld electrode of a spot welder or a laser head of a laser welder, the tab slot head may be wider than and have a distinct shape from the tab slot body. When the tabs are cut or pressed from a metal panel, the tab slots may take on the same general size and geometric form (e.g., a lightbulb-shape) as the interlock tabs. For simplicity of design and efficiency of assembly, the interlock tabs may be rigidly mounted via weld joints to the inboard face of the first panel. To this end, the interlocked panels may be substantially flat, may be substantially parallel to each other, and may both be fabricated from the same metallic material (e.g., cut or stamped from aluminum or steel sheet stock or roll stock).

For any of the disclosed panel assemblies, vehicles, and methods, the tab matrix may include multiple mutually parallel tab rows that are substantially orthogonal with multiple mutually parallel interlock tab columns. In this instance, the interlock tab rows may include a first set of tab rows in which the interlock tabs project in a first direction, and a second set of tab rows in which the interlock tabs project in a second direction opposite the first direction. As a further option, the interlock tab columns may include a first set of tab columns, each of which contains a respective first plurality of the interlock tabs, and a second set of tab columns, each of which contains a respective second plurality of the interlock tabs. In this instance, the interlock tabs of one tab column are staggered with the interlock tabs of at least one of its neighboring tab columns.

For any of the disclosed panel assemblies, vehicles, and methods, the predefined matrix pattern may include a matrix of tab cells interleaved with one another. Each of these tab cells may contain a respective cluster of the interlock tabs arranged in an equilateral triangle pattern, i.e., with the interlock tabs angled approximately 60° apart from one another. It may be desirable that each cell cluster of interlock tabs contains: (1) a first interlock tab that points in a first direction; (2) a second interlock tab that points in a second direction distinct from the first direction; and (3) a third interlock tab that points in a third direction distinct from the first and second directions. It is envisioned that the shape of each tab, size of each tab, the total number of interlock tabs, the density of interlock tabs, and/or the matrix pattern of interlock tabs may be selectively varied to achieve different applications, loading conditions, material considerations, packaging constraints, etc.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is an elevated, perspective-view illustration of a representative motor vehicle with an inset view of the underside of the vehicle chassis frame showing a load-bearing underbody shear panel assembly in accordance with aspects of the present disclosure.

FIG. 2 is an isometric illustration of a representative multilayer structural panel assembly with a triangular-matrix pattern of interlock tabs in accordance with aspects of the present disclosure.

FIG. 3 is an isometric illustration of a representative multilayer structural panel assembly with a square-matrix pattern of interlock tabs in accordance with aspects of the present disclosure.

FIG. 4 is a side-view illustration of the representative multilayer structural panel assembly of FIG. 2 showing the angled-matrix inter-panel connection.

FIG. 5 is a side-view illustration of the representative multilayer structural panel assembly of FIG. 3 showing the angled-matrix inter-panel connection.

FIGS. 6A and 6B are perspective and side-view illustrations, respectively, of a representative manufacturing system and process for fabricating multilayer structural panel assemblies in accord with aspects of the disclosed concepts.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Furthermore, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless explicitly disclaimed: the singular includes the plural and vice versa (e.g., indefinite articles “a” and “an” are to be construed as meaning “one or more” unless expressly disclaimed); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

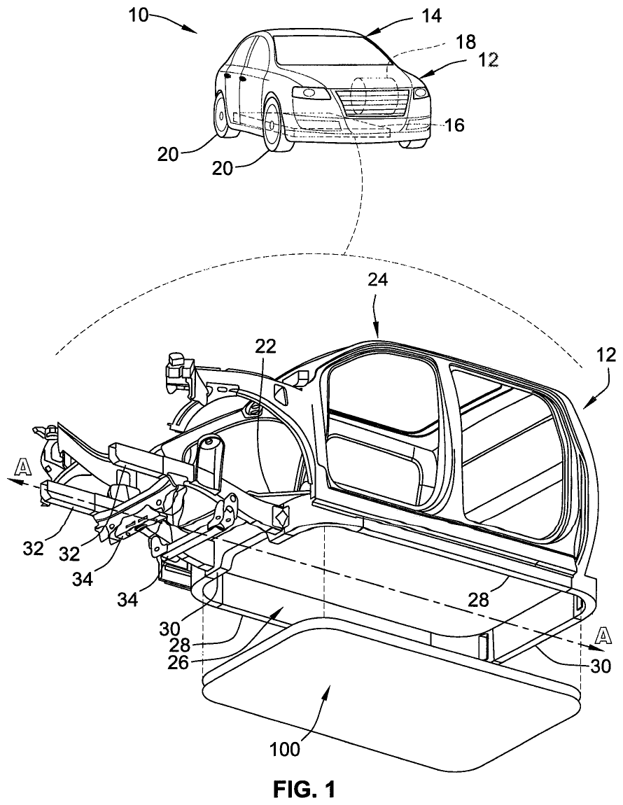

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which aspects of this disclosure may be practiced. In the same vein, incorporation of the present concepts into a load-bearing shear panel assembly for supporting and protecting a traction battery pack should be appreciated as a non-limiting implementation of disclosed features. As such, it will be understood that aspects and features of this disclosure may be applied to other vehicle panel structures, incorporated into any logically relevant type of motor vehicle, and utilized for both automotive and non-automotive applications alike. Furthermore, only select components of the motor vehicles and panel assemblies are shown and described in detail herein. Nevertheless, the vehicles and assemblies discussed below may include numerous additional and alternative features, and other available peripheral hardware, for carrying out the various methods and functions of this disclosure.

Vehicle 10 of FIG. 1 may take on assorted electric-drive vehicle configurations that necessitate improved underbody protection, such as a hybrid electric vehicle (HEV), a plug-in electric vehicle (PEV), an extended-range electric vehicle (E-REV), or a battery electric vehicle (BEV), as some non-limiting examples. To provide the requisite power for operating the powertrain, the vehicle 10 is equipped with a rechargeable energy storage system (RESS), which is represented in FIG. 1 by a high-voltage, high ampere-hour traction battery pack 16 that contains an assemblage of rechargeable (secondary) battery cells or other suitable type of electric vehicle battery (EVB). Traction battery pack 16, for example, may include a protective and insulated battery pack housing (not shown) that securely stores therein a series of cylindrical, prismatic, or pouch-type battery cells (not shown), such as a stack of self-contained, hermetically sealed lithium-ion (Li-ion), lithium-polymer (LiPo), and/or nickel-metal hydride (NiMH) battery cells, for example. While a variety of different battery configurations and packaging locations are envisioned, the traction battery pack 16 is shown mounted inside the vehicle's outer body 12 and underneath the vehicle's passenger compartment 14. The battery pack 16 is electrically coupled to and powers an electric traction motor-generator unit (MGU) 18 that operates to drive one or more of the vehicle's road wheels 20 to thereby propel the vehicle 10.

With reference to the inset view of FIG. 1, the vehicle 10 may be constructed with a rigid floor pan 22 that extends across the top of the battery pack housing to separate the traction battery pack 16 from the interior of the passenger compartment 14. The floor pan 22 and battery pack 16 are anchored to a vehicle chassis frame 24 that supports thereon the vehicle body 12 (e.g., in a ladder-frame construction) or, alternatively, is combined with select portions of the vehicle body 12 (e.g., in a unibody-frame construction). Located underneath the passenger compartment 14 and floor pan 22 is a load-bearing shear panel assembly 100, which is rigidly mounted, e.g., via mounting studs or rivets, onto the vehicle chassis frame 24 and provides subjacent support for the traction battery pack 16. Once properly mounted, the floor pan 22 and shear panel assembly 100 (also referred to herein as “structural panel assembly”) define the upper and lower extents of a battery storage compartment 26 within which is securely stowed the traction battery pack 16. In accord with the illustrated example, the shear panel assembly 100 may be an abrasion-resistant skid plate that acts as an aerodynamic underbody panel and a shield for protecting the underside of the traction battery pack 16.

Chassis frame 24 is formed with a pair of generally parallel box-girder-type chassis side rails 28 (referred to in the art as “rocker sills”) that are laterally spaced from each other and longitudinally elongated with respect to the vehicle's fore-aft center axis A-A. A series of transversely oriented U-shaped cross members—two of which are labelled at 30 in FIG. 1—are longitudinally spaced apart from one another and function to interconnect the chassis side rails 28. Projecting from a front-most terminal end of each chassis side rail 28 is a respective cradle side rail 32. A pair of front cradle cross members 34 extend between and rigidly mount to the two chassis side rails 28 to cooperatively define a front suspension cradle, which provides mount support for the electric traction motor 16 and protection to the passenger cabin 14 and battery storage compartment 26 during a front-impact or side-impact event.

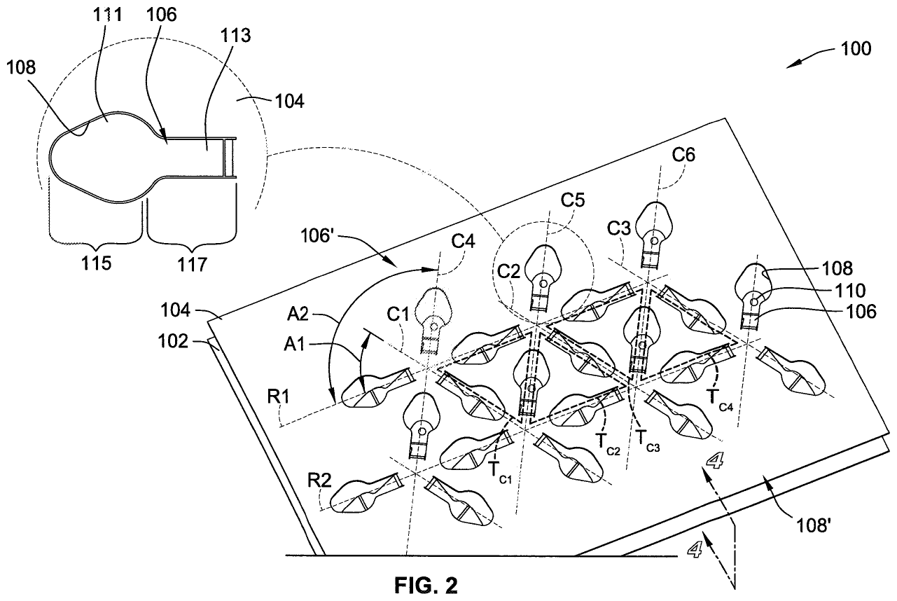

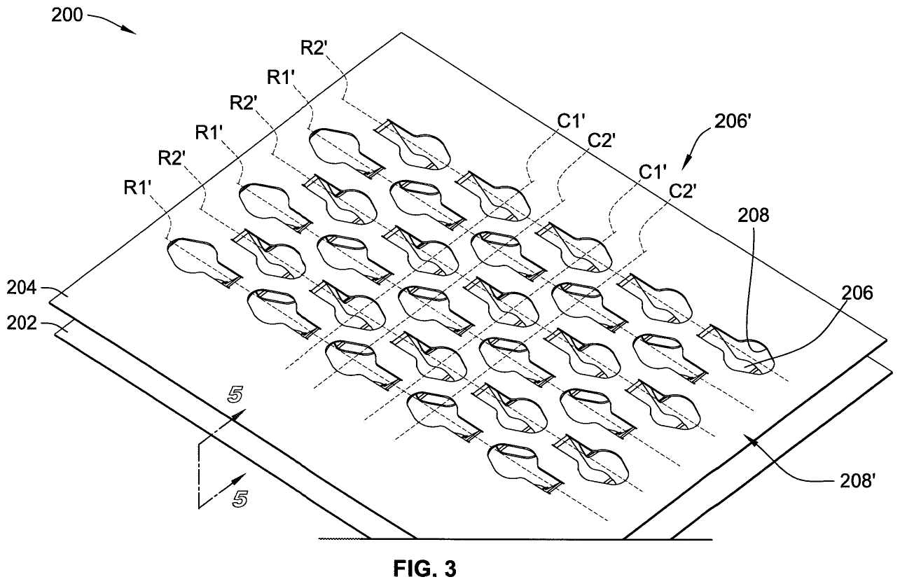

Presented in FIGS. 2 and 3 are representative examples of multilayer structural panel assemblies 100 and 200, respectively, that may provide lightweight and high-strength structural support for a vehicle component, such as battery pack 16 of automobile 10 of FIG. 1, while reducing total part count and minimizing gross vehicle weight (GVW). In both examples, the structural panel assembly 100, 200 may be fabricated as a bipartite construction that includes or, if desired, consists essentially of two sheet-metal panels that are joined by a matrix of integral tabs that projects from one panel and secures to the other. Advantageously, disclosed panel assemblies may be agnostic to material choice, enabling the use of various materials and material combinations. Furthermore, disclosed bent tab structures may enable efficient material utilization, resulting in a high specific stiffness to withstand both static and dynamic loads while minimizing assembly deformation. Disclosed bent tab structures may be tailored to a myriad of material responses and loading conditions, including load cases that necessitate an isotropic material response.

Simplified panel assembly designs may help to enable versatile manufacturing methods, including high-speed progressive die manufacturing, and flexible manufacturing options, including shearing, laser or waterjet cutting, etc., allowing for customization to different applications. Joining of the sheet-metal panels may be achieved using available metal-fusing processes (e.g., spot welding, laser welding, etc.), metal-fastening processes, (e.g., riveting, bolting, etc.), or any other suitable material-joining process. Enabling the use of high-speed continuous manufacturing processes may help to improve efficiency and productivity with a concomitant reduction in labor and manufacturing expenditures. Disclosed open matrix designs may enable the use of interior void spaces for various purposes, such as transverse reinforcement retention bars, HVAC ducting, electrical conduits, structural foams, pack venting and cooling, etc. Moreover, disclosed open matrix designs may enable efficient fluid drainage capabilities that may otherwise be precluded by closed “sandwich-style” panel assemblies.

In addition to being implemented as load-bearing and load-transferring shear panels for supporting and protecting electric vehicle batteries, disclosed panel assembly designs may be adapted for use in other structural panel applications and, for that matter, may be used in both automotive and non-automotive applications alike. For instance, the tab array panel may enable an open “MOLLE” (Modular Lightweight Load-carrying Equipment) style retention system, which may be implemented for customer-facing storage applications in large transport vehicles or for attaching secondary components during vehicle processing. It is also envisioned that disclosed structural panel assemblies may increase specific performance by incorporating one or more optional layers, such as the addition of a corrugated panel, a structural foam core, etc., and by engineering the tab matrix interlock design for a specific load/failure propagation.

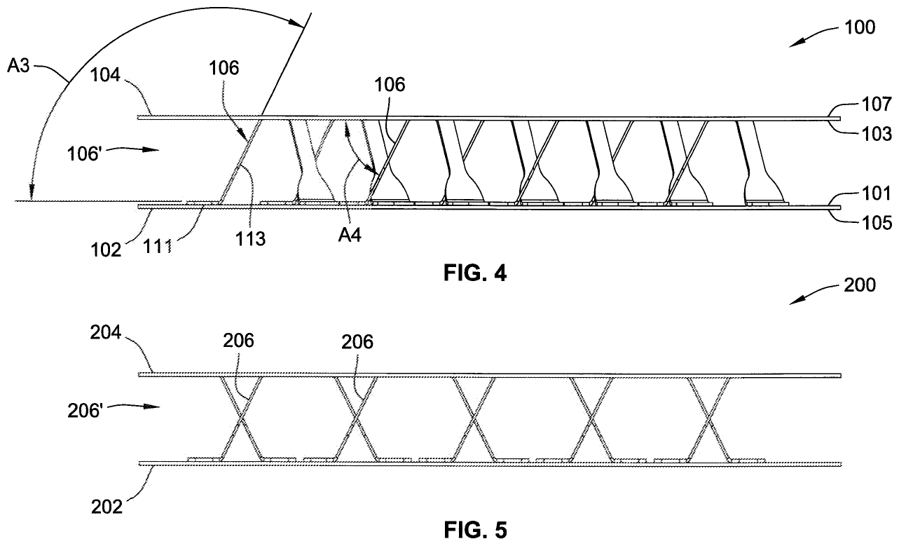

Turning to FIG. 2, the structural panel assembly 100 is manufactured with two interconnected panels: a base (first) panel 102 that is formed, in whole or in part, from a base panel (first) metallic material; and a cover (second) panel 104 that is formed, in whole or in part, from a cover panel (second) metallic material. To reduce assembly weight and simplify assembly design, the structural panel assembly 100 may be fabricated as a bipartite construction that consists essentially of the two metallic panels 102, 104. Doing so eliminates superfluous parts, such as foam cores, polymeric fascias, central mounting structures and mounting brackets, fasteners, etc. However, a bipartite panel assembly 100 design may incorporate additional features that do not materially affect the key, functional attributes of the assembly, such as corrosion-resistant coatings, weatherproofing sealants, paint, component-anchoring interfaces, chassis-mounting interfaces, fluid plumbing, electrical conduits, etc. As best seen in FIG. 4, both panels 102, 104 have a respective inward-facing (inboard) face 101 and 103 opposite a respective outward-facing (outboard) face 105 and 107. The two panels 102, 104 are stacked in spaced face-to-face relation such that their inboard faces 101, 103 face each other. While not per se required, the panels 102, 104 may be substantially flat, may be substantially parallel to each other, and may both be fabricated from the same metallic material (e.g., cut or stamped from aluminum or steel sheet stock or roll stock).

To securely interconnect the two panels 102, 104, one or both panels 102, 104 is fabricated with integral interlock tabs that are arranged in a predefined matrix pattern that is engineered to ensure a preset minimum weight capacity, e.g., during static loading conditions, while providing a predetermined impact-attenuating response, e.g., during dynamic loading conditions. By way of example, and not limitation, the cover panel 104 is manufactured with a matrix 106′ of interlock tabs 106 that is arranged in intersecting matrix rows and columns, which are represented in FIG. 2 by a set of mutually parallel interlock tab rows R1 and R2, a first set of mutually parallel interlock tab columns C1-C3, and a second set of mutually parallel interlock tab columns C4-C6. In this example, each column in the first set of columns C1-C3 is angularly offset from each of the interlock tab rows R1 and R2 by a first oblique angle A1, whereas each column in the second set of columns C4-C6 is angularly offset from each of the interlock tab rows R1 and R2 by a second oblique angle A1. The first oblique angle A1 may be about 45° to about 75° or, for some implementations, approximately 60°, whereas the second oblique angle A2 may be about 105° to about 135° or, for some designs, approximately 120°.

While shown with two rows R1-R2 that intersect with six columns C1-C6, it should be appreciated that the number of rows and columns, as well as the angular offset therebetween, of the interlock tab matrix pattern may be varied from that which are shown in the drawings. In the same vein, the cover panel 104 is shown with a total of twenty-one (21) interlock tabs 106; however, the total number of interlock tabs, the density of the interlock tabs, and/or the number of tabs in each row/column may be selectively varied. As a further option, the tabs may be formed in only the cover panel 104 (as shown), in only the base panel 102, or in both of the panels 102, 104.

To help reduce the weight and total part count of the assembly 100, the cover panel 104, including the matrix 106′ of interlock tabs 106, may be integrally formed as a unitary, single-piece structure from a metallic material. As mentioned above, for example, a predefined pattern of interlock tabs 106 may be machined, e.g., via laser cutting, press punching, or other suitable metalworking process, from an aluminum or steel blank. By machining the tabs 106 from the panel 104, the cover panel 104 will define therethrough a matrix 108′ of tab slots 108 that are aligned with and, thus, arranged in the same predefined matrix pattern as the interlock tabs 106. In this instance, each of the interlock tabs 106 may project from an inner edge of a respective one of the tab slots 108. Similar to the interlock tabs 106 of FIG. 2, the total number, density, and/or arrangement of the tabs slots 108 may be selectively varied from the illustrated example.

With continuing reference to FIG. 2, the predefined matrix pattern may incorporate a matrix of polygonal tab cells—four of which are labelled at T_{C1}-T_{C4}—that are interleaved with one another along the length and the width of the tab-originating panel 104. While a variety of different shapes and sizes are envisioned, each of the tab cells T_{C1}-T_{C4} is shown in FIG. 2 having a respective cluster of three interlock tabs 106 arranged in an equilateral triangle shape, i.e., with the interlock tabs of each cell angled approximately 60° apart from one another. It may be desirable that each tab cell T_{C1}-T_{c4} contains: (1) a first interlock tab 106 that points in a first direction (e.g., upwards and to the right in FIG. 2); (2) a second interlock tab 106 that points in a second direction distinct (e.g., downwards and to the right in FIG. 2); and (3) a third interlock tab 106 that points in a third direction distinct (e.g., downwards and to the left in FIG. 2).

Each of the interlock tabs 106 may take on a variety of different regular and irregular geometric forms; however, it may be desirable that all of the tabs 106 share a common shape and size. The inset view of FIG. 2, for example, shows a single interlock tab 106 after being cut/punched from the cover panel 104 but before being bent towards the base panel 102. Each tab 106 may have an elongated and contoured shape with an oblong tab head 111 that is integral with a polygonal tab body 113. In this example, a proximal (first) terminal end of the tab body 113 adjoins the cover panel 104, whereas a distal (second) terminal end of the tab body 113 adjoins the tab head 111. It may be desirable that the tab head 111 is substantially flat and oval, and the tab body 113 is substantially flat and rectangular. As best seen in FIG. 4, the tab head 111 may project at a third oblique angle A3 from the tab body 113. The third oblique angle A3 may be about 120° to about 150° or, for some designs, approximately 135°. In accord with the illustrated example, each tab slot 108 may also have an elongated shape with an oblong tab slot head 115 that adjoins a polygonal tab slot body 117. To accommodate a weld electrode of a spot welder or a laser head of a laser welder, each of the tab slots' heads 115 may be wider than and have a distinct shape from the tab slots' bodies 117. When the tabs 108 are cut or pressed from a cover panel 104, the tab slots 108 may take on the same general size and geometric form (e.g., lightbulb shaped) as the interlock tabs 106.

To join the base panel 102 to the cover panel 104, the matrix 106′ of interlock tabs 106 projects downward from the inboard face 103 of the cover panel 104 and rigidly mounts to the inboard face 101 of the base panel 102 such that the tabs 106 act as deformable support stanchions. As best seen in FIG. 4, for example, each of the interlock tabs 106 projects from the cover panel 104 at a fourth oblique angle A4, which may be about 30° to about 60° or, for some applications, approximately 45°. The interlock tabs 106 of the cover panel 104 are rigidly mounted, e.g., via weld joints 110 (FIG. 2), to the inboard face 101 of the base panel 102. FIG. 4 shows the tab body 113 portion of the interlock tab 106 projecting at the oblique angle A4 from the cover panel 104, and the tab head 111 laying substantially flush against and rigidly mounting to the base panel 102.

Similar to the structural panel assembly 100 of FIG. 2, the structural panel assembly 200 of FIG. 3 is also fabricated with two interconnected panels, namely a metallic base panel 202 that is stacked in spaced face-to-face relation with a metallic cover panel 204. Although differing in appearance, it is envisioned that the panel assembly 200 of FIGS. 3 and 5 may include any of the features and options described above with respect to the panel assembly 100 of FIGS. 2 and 4, and vice versa. As another point of similarity, the structural panel assembly 200 may be fabricated as a bipartite construction that consists essentially of the two metallic panels 202, 204. Moreover, each of the panels 202, 204 may be formed as a one-piece structure, may be substantially flat, may be substantially parallel to each other, and may be fabricated from the same metallic material. In addition, the cover panel 204 is manufactured with a matrix 206′ of thirty (30) interlock tabs 206 aligned with a matrix 208′ of thirty (30) interlock tabs slots 208.

As a point of demarcation from the panel assembly 100 of FIG. 2, the interlock tabs 206 and slots 208 of the panel assembly 200 if FIG. 3 are arranged in a predefined matrix pattern that is defined by multiple mutually parallel tab rows R1′ and R2′ that are substantially orthogonal with multiple mutually parallel interlock tab columns C1′ and C2′. In this example, the mutually parallel rows of interlock tabs may be delineated into a first set of tab rows R1′ that each contains interlock tabs 206 that project in a first direction (e.g., to the left in FIG. 3), and a second set of tab rows R2′ that each contains interlock tabs 206 that project in a second direction (e.g., to the right in FIG. 3), which is opposite that of the tabs in the first set. In a similar respect, the mutually parallel columns of interlock tabs may be delineated into a first set of tab columns C1′ that each contains a respective set of the interlock tabs 206, and a second set of tab columns C2′ that each contains a respective set of the interlock tabs 206. In this instance, the interlock tabs 206 in each of the columns C1′ are staggered with the interlock tabs in one or both neighboring columns C2′.

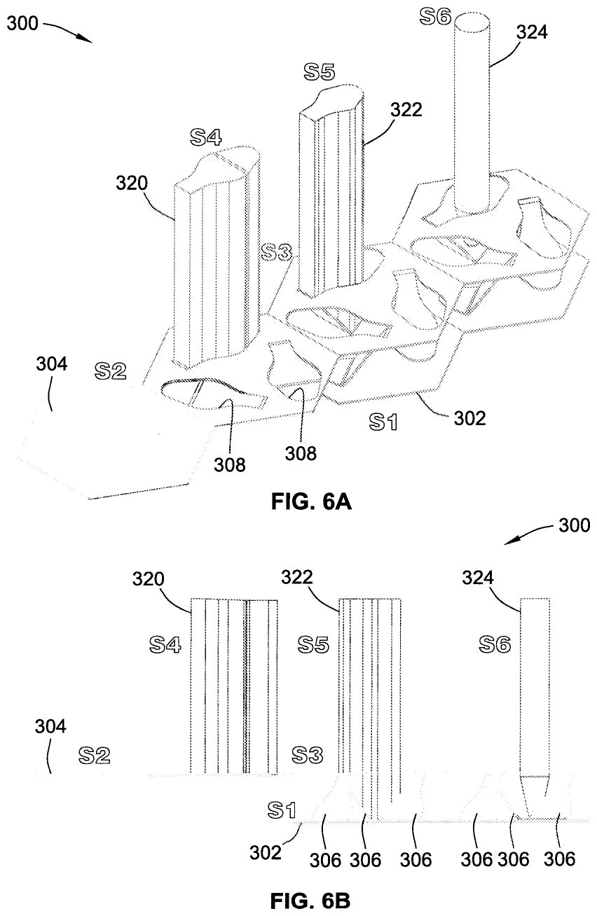

FIGS. 6A and 6B illustrate a representative manufacturing system and process, collectively designated as 300, for fabricating a multilayer structural panel assembly, such as the structural panel assemblies 100 and 200 of FIGS. 2 and 3. Some or all of the operations illustrated in FIGS. 6A and 6B and described in further detail below may be representative of an algorithm that corresponds to non-transitory, processor-executable instructions that are stored, for example, in a main or auxiliary or remote memory device or network of memory devices, and executed, for example, by an electronic controller, processing unit, dedicated control module, logic circuit, or other module or device or network of modules/devices, to perform any or all of the above and below described functions associated with the disclosed concepts. It should be recognized that the order of execution of the illustrated operation blocks may be changed, additional operation blocks may be added, and some of the herein described operations may be modified, combined, or eliminated. The base panels 102, 202 and cover panels 202, 204 of FIGS. 2-5 may be represented by first and second panels 302 and 304, respectively, in FIGS. 6A and 6B.

At a first manufacturing process step/station S1, the system/method 300 forms, accepts, retrieves, and/or secures (collectively “receives”) a first panel 302 that is formed, in whole or in part, from a first metallic material. At a second manufacturing process step/station S2, the system/method 300 receives a second panel 304 that is formed, in whole or in part, from a second metallic material. At a third manufacturing process step/station S3, the first and second panels 302, 304 are aligned such that the inboard face (e.g., first inboard face 101 of FIG. 4) of the first panel 102 faces the inboard face (e.g., second inboard face 103 of FIG. 4) of the second panel 304. It is envisioned that the first, second and third steps/stations S1-S3 may be reordered or may be combined into a single step/station.

Advancing from steps/stations S1-S3, the manufacturing system/method 300 machines the second panel 304 to include a plurality of interlock tabs 306 that is arranged in a predefined matrix pattern, such as the interlock tab matrices 106′, 206′ shown in FIGS. 2 and 3. At a fourth manufacturing process step/station S4, for example, the second panel 304 may be machined by stamping or cutting the interlock tabs 306 from the second panel 304, e.g., using a die punch 320. As best seen in FIG. 6A, the interlock tabs 306 may take on an elongated shape with a tab body (e.g., tab body 113 of FIG. 2), which is adjoined at a first end thereof to the second panel 306 and at a second end thereof to a tab head (e.g., tab head 111 of FIG. 2). Stamping or cutting the tab slots 306 from the second panel 304 will concomitantly generate a plurality of tab slots 308 that is aligned with the interlock tabs 306 and arranged in the same matrix pattern as the tabs 306.

Advancing from machining step/station S4, the manufacturing system/method 300 bends the interlock tabs 306 to project at an oblique angle from the inboard face of the second panel 304. At a fifth manufacturing process step/station S5, for example, the interlock tabs 306 may be bent by pressing the tab body, e.g., using a hydraulic press tool 322, to project downward at a 45±3° angle from the second panel 304. Once bent, the interlock tabs 306 are securely mounted to the inboard face of the first panel 302 to thereby join the first and second panels 302, 304. At a sixth manufacturing process step/station S6, for example, the tab heads of the interlock tabs 306 are welded, e.g., using a spot/laser welding head 324, to the inboard face of the first panel 302. Alternatively, the tab heads may be fastened, clinched, rivetted, etc., to the inboard face of the first panel 302.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A structural panel assembly, comprising:
a first panel formed with a first metallic material and having a first inboard face opposite a first outboard face; and
a second panel formed with a second metallic material and having a second inboard face opposite a second outboard face, the second inboard face facing the first inboard face, the second panel including a plurality of interlock tabs arranged in a predefined matrix pattern, the interlock tabs projecting at an oblique angle from the second inboard face and rigidly mounted to the first inboard face to thereby join the first and second panels.

2. The structural panel assembly of claim 1, wherein the second panel, including the interlock tabs, is integrally formed as a single-piece structure from the second metallic material.

3. The structural panel assembly of claim 1, wherein each of the interlock tabs has an elongated shape with a tab head and a tab body, the tab body adjoined at a first end thereof to the second panel and at a second end thereof to the tab head, the tab body projecting at the oblique angle from the second inboard face, and the tab head rigidly mounted to the first inboard face.

4. The structural panel assembly of claim 3, wherein the tab body is substantially flat and rectangular, the tab head is substantially flat and oval, and the tab head projects at an oblique angle from the tab body.

5. The structural panel assembly of claim 1, wherein the second panel further includes a plurality of tab slots arranged in the predefined matrix pattern and aligned with the interlock tabs, each of the interlock tabs projecting from an inner edge of a respective one of the tab slots.

6. The structural panel assembly of claim 5, wherein each of the tab slots has an elongated shape with a tab slot head adjoining a tab slot body, and wherein the tab slot head is wider than and has a distinct shape from the tab slot body.

7. The structural panel assembly of claim 1, wherein the predefined matrix pattern includes mutually parallel tab rows substantially orthogonal with mutually parallel tab columns.

8. The structural panel assembly of claim 7, wherein the tab rows include a first set of tab rows with the interlock tabs projecting in a first direction, and a second set of tab rows with the interlock tabs projecting in a second direction opposite the first direction.

9. The structural panel assembly of claim 7, wherein the tab columns include a first set of tab columns each containing a first plurality of the interlock tabs, and a second set of tab columns each containing a second plurality of the interlock tabs staggered with the first plurality of the interlock tabs in a neighboring one of the first set of tab columns.

10. The structural panel assembly of claim 1, wherein the predefined matrix pattern includes a matrix of tab cells interleaved with one another, each of the of tab cells containing a respective cluster of the interlock tabs arranged in a triangle pattern.

11. The structural panel assembly of claim 10, wherein each of the respective clusters of the interlock tabs includes a first interlock tab pointing in a first direction, a second interlock tab pointing in a second direction distinct from the first direction, and a third interlock tab pointing in a third direction distinct from the first and second directions.

12. The structural panel assembly of claim 1, wherein the interlock tabs of the second panel are rigidly mounted via weld joints to the first inboard face of the first panel.

13. The structural panel assembly of claim 1, wherein the first and second panels are substantially flat and substantially parallel to each other, and wherein the first metallic material is the same as the second metallic material.

14. A motor vehicle, comprising:
a vehicle body with a vehicle chassis frame;
a plurality of road wheels attached to the vehicle body;
a traction motor attached to the vehicle body and configured to drive one or more of the road wheels to thereby propel the motor vehicle;
a traction battery pack attached to the vehicle body and configured to power the traction motor; and
a structural shear panel assembly supporting thereon the traction battery pack and rigidly mounted to the vehicle chassis frame, the shear panel assembly consisting essentially of:
a first panel integrally formed as a one-piece structure from a first metallic material and having a first inboard face opposite a first outboard face; and
a second panel integrally formed as a one-piece structure from a second metallic material and having a second inboard face opposite a second outboard face, the second inboard face facing the first inboard face, the second panel including a plurality of interlock tabs arranged in a predefined matrix pattern, the interlock tabs projecting at an oblique angle from the second inboard face and mounted via weld joints to the first inboard face to thereby join the first and second panels.

15. A method of manufacturing a structural panel assembly, the method comprising:
receiving a first panel formed with a first metallic material and having a first inboard face opposite a first outboard face;
receiving a second panel formed with a second metallic material and having a second inboard face opposite a second outboard face;
aligning the first and second panels such that the second inboard face faces the first inboard face;
fabricating the second panel to include a plurality of interlock tabs arranged in a predefined matrix pattern;
bending the interlock tabs to project at an oblique angle from the second inboard face; and
mounting the interlock tabs to the first inboard face to thereby join the first and second panels.

16. The method of claim 15, wherein the received second panel, including the interlock tabs, is integrally formed as a single-piece structure from the second metallic material.

17. The method of claim 15, wherein fabricating the second panel includes stamping or cutting each of the interlock tabs from the second panel to include an elongated shape with a tab head and a tab body, the tab body adjoined at a first end thereof to the second panel and at a second end thereof to the tab head.

18. The method of claim 17, wherein bending the interlock tabs includes pressing the tab body to project from the second inboard face at the oblique angle.

19. The method of claim 18, wherein mounting the interlock tabs includes spot welding or laser welding the tab head to the first inboard face of the first panel.

20. The method of claim 15, wherein fabricating the second panel includes stamping or cutting a plurality of tab slots into the second panel such that the tab slots are arranged in the predefined matrix pattern and aligned with the interlock tabs, each of the interlock tabs projecting from an inner edge of a respective one of the tab slots.
